(19) United States
(12) Patent Application Publication
(10) Pub. No.: US 2026/0208732 A1
(43) Pub. Date: Jul. 23, 2026

(54) DRIVER ASSISTANCE APPARATUS, DRIVER ASSISTANCE METHOD, AND A NON-TRANSITORY COMPUTER-READABLE STORAGE MEDIUM STORING A PROGRAM

(71) Applicant: TOYOTA JIDOSHA KABUSHIKI KAISHA, Toyota-shi (JP)

(72) Inventor: Takahiko OGIHARA, Gotenba-shi (JP)

(73) Assignee: TOYOTA JIDOSHA KABUSHIKI KAISHA, Toyota-shi (JP)

(21) Appl. No.: 19/395,061

(22) Filed: Nov. 20, 2025

(30) Foreign Application Priority Data
Jan. 20, 2025 (JP) 2025-007399

(51) Int. Cl. B60W 30/18; B60W 30/14; B60W 40/09

(52) U.S. Cl. CPC B60W 30/18072; B60W 30/146; B60W 40/09; B60W 2552/40; B60W 2554/406; B60W 2555/20

(57) ABSTRACT

When a deceleration condition is satisfied, a controller executes either a coasting control or a deceleration control. The coasting control is a control for setting a connection state between a drive source and drive wheels to a power cutoff state in which power is not transmitted therebetween, and for causing the vehicle to coast. The deceleration control is a control for setting the connection state to a power transmission state in which power is transmitted therebetween, and for causing the vehicle to decelerate by causing an external force input from the drive wheels to be transmitted to the drive source. The controller obtains information indicative of driving circumstances of the host vehicle and determines, based on the obtained information indicative of the driving circumstances of the host vehicle, which one of the coasting control and the deceleration control is to be executed.

### TECHNICAL FIELD

The present disclosure relates to a driver assistance apparatus, a driver assistance method for controlling a vehicle to coast, and a non-transitory computer-readable storage medium storing a program thereof.

### BACKGROUND

One of the conventional apparatuses of this kind (hereinafter, simply referred to as a “conventional apparatus”) comprises a control section configured to decelerate a host vehicle to a full stopping position. The control section is configured to perform either a first deceleration control in which the vehicle performs cruise travel and then braking is applied to the host vehicle or a second deceleration control in which the vehicle coasts and then fuel cut is performed (refer to Japanese Patent Application Laid-Open No. 2019-137228).

### SUMMARY

However, the conventional apparatus causes the host vehicle to coast without taking into account whether driving circumstances are suitable for coasting. The driving circumstances include, for instance, the condition of a road surface on which the host vehicle is traveling, weather in an area in which the host vehicle is traveling, road construction or traffic congestion in the area in which the host vehicle is traveling, and traveling state of a preceding vehicle of the host vehicle.

Accordingly, there may be a case where coasting is performed in a state in which coasting is not suitable (e.g., a state in which coasting causes the driver to feel uneasy).

The present disclosure is made to cope with the problem described above. That is, one of the objects of the present disclosure is to provide a driver assistance apparatus, a driver assistance method, and a non-transitory computer-readable storage medium storing a program thereof, that are configured to cause the host vehicle to coast when the driving circumstances are suitable for coasting and not to cause the host vehicle to coast when the driving circumstances are not suitable for coasting. Note that “step” may hereinafter be expressed as “S”.

One of aspects of the driver assistance apparatuses according to the present disclosure comprises a controller (10) configured to execute either a coasting control (S270) or a deceleration control (S235), when a predetermined deceleration condition for decelerating a host vehicle becomes satisfied (S205: Yes, S210: No).

The coasting control is a control for setting a connection state between a drive source of the host vehicle and drive wheels of the host vehicle to a power cutoff state in which power is not transmitted between the drive source and the drive wheels and for causing the vehicle to coast.

The deceleration control is a control for setting the connection state to a power transmission state in which power is transmitted between the drive source and the drive wheels and for causing the vehicle to decelerate by causing an external force input from the drive wheels to be transmitted to the drive source.

The controller is configured to:

obtain information indicative of driving circumstances of the host vehicle (S220, S240); and

determine, based on the obtained information indicative of the driving circumstances of the host vehicle, which one of the coasting control and the deceleration control is to be executed (S225, S245).

According to this configuration, the coasting control is executed or is not executed depending on the information indicative of the driving circumstances of the host vehicle. Therefore, the probability that the coasting control is executed when the driving circumstances are not suitable for the coasting control is reduced. As a result, the probability that the driver feels uneasy can be reduced.

Notably, in the above description, in order to facilitate understanding of the present disclosure, the constituent elements corresponding to those of an embodiment which will be described later are accompanied by parenthesized symbols and/or names which are used in the embodiment; however, the constituent elements of the disclosure are not limited to those in the embodiment defined by the symbols and/or names. The present disclosure also covers a driver assistance method, and a non-transitory computer readable storage medium having stored therein a program that causes a computer mounted on the vehicle to execute steps in the driver assistance method.

### BRIEF DESCRIPTION OF THE DRAWINGS

FIG. 1 is a schematic diagram of a driver assistance apparatus according to an embodiment of the present disclosure.

FIG. 2 shows a routine executed by a CPU of the driver assistance ECU shown in FIG. 1.

FIG. 3 shows a sub-routine executed by the CPU of the driver assistance ECU shown in FIG. 1.

FIG. 4 shows another sub-routine executed by the CPU of the driver assistance ECU shown in FIG. 1.

FIG. 5 shows yet another sub-routine executed by the CPU of the driver assistance ECU shown in FIG. 1.

### DETAILED DESCRIPTION

### Configuration

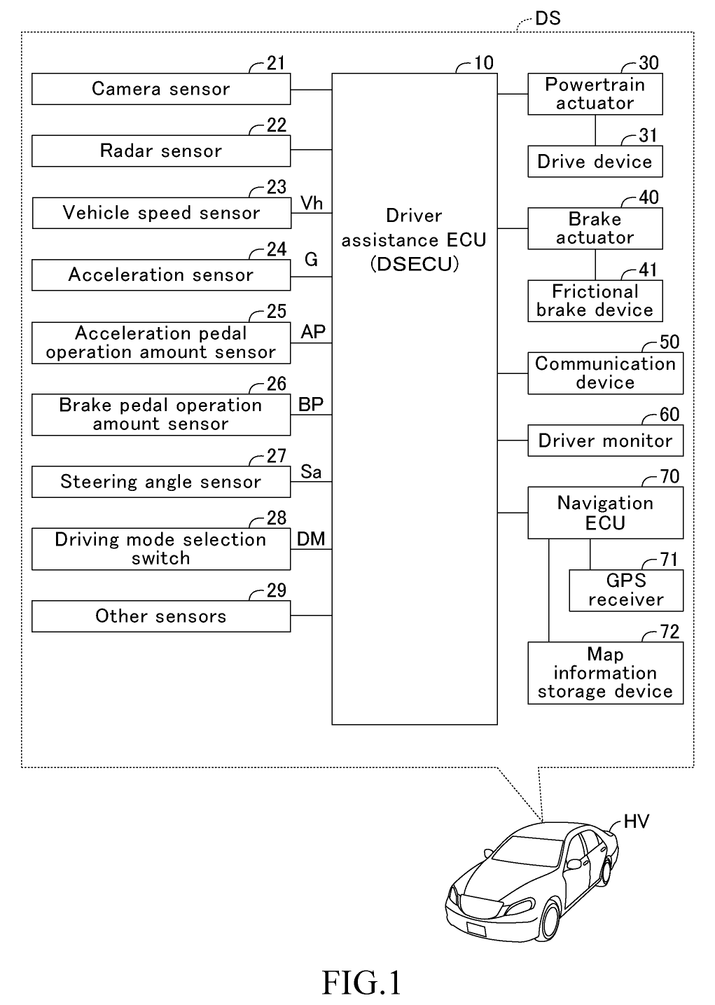

A driver assistance apparatus (hereinafter, referred to as an "apparatus DS") according to an embodiment of the present disclosure comprises the elements (components) shown in FIG. 1. The apparatus DS is applied to (i.e., is mounted on) a host vehicle HV. The host vehicle HV may be a vehicle having an internal combustion engine as a drive source, a vehicle having an electric motor as a drive source (namely, an electric vehicle), or a hybrid vehicle having both an internal combustion engine and an electric motor as drive sources.

In the present specification, an ECU refers to an electronic control device/unit comprising a microcomputer. The microcomputer includes a CPU (i.e., a processor), a ROM, a RAM, a non-volatile memory in which data can be written, and an interface. The CPU realizes various functions by executing routines (e.g., instructions) stored in the memory (i.e., the ROM). The ECU may also be referred to as a controller or a computer.

The driver assistance ECU 10 executes a deceleration assistance control, which will be described later, as a driver assistance control. The driver assistance ECU 10 is connected to the elements (components) described below, and transmits signals to, or receives signals from, those elements. The driver assistance ECU 10 may be implemented by multiple ECUs.

The camera sensor 21 is configured to obtain image data by capturing an image of a scene surrounding the host vehicle HV including a scene in front of the host vehicle HV, every time a predetermined time elapses. The driver assistance ECU 10 is configured to obtain, based on the image data, a position of an object present around the host vehicle (e.g., another vehicle including a preceding vehicle), a position of various kinds of lines painted on the road surface (e.g., a lane demarcation line), a road surface condition (e.g., whether the road surface is frozen, whether there is a mud including a puddle), or the like. In addition, the driver assistance ECU 10 is configured to obtain, based on the image data, information indicating whether a deceleration-requiring target (or factor) is present, information specifying a type of the deceleration-requiring target, and the like. These pieces of information obtained based on the image data acquired by the camera sensor 21 may be referred to as “camera information.”

The deceleration-requiring target represents the driving circumstance indicating that the host vehicle HV is required to decelerate before the host vehicle HV reaches the deceleration-requiring target. For example, the deceleration-requiring target includes at least one of a stop sign indicating a temporary stop, a stop line indicating a temporary stop, a curve (curved road) present in front of the host vehicle HV, a traffic signal in which the red light is turned on, a railroad crossing signal, a gate provided at an entrance to a toll road.

The radar sensor 22 is a well-known sensor configured to obtain information indicative of an object present in front of (or ahead of) the vehicle, using electromagnetic waves in a millimeter-wave band. The radar sensor 22 sends millimeter wave information on the transmitted and received millimeter waves to the driver assistance ECU 10. The driver assistance ECU 10 obtains “radar information” based on the millimeter wave information. The radar information includes a distance to an object (e.g., an other vehicle, that is a vehicle different from the host vehicle HV, including a preceding vehicle), an azimuth of the object, and a relative speed of the object.

The driver assistance ECU 10 generates fusion information by fusing the camera information with the radar information.

The vehicle speed sensor 23 is configured to output a signal indicative of a speed (i.e., vehicle speed) Vh of the host vehicle HV.

The acceleration sensor 24 is configured to output a signal indicative of an acceleration G of the host vehicle HV in a front-rear direction.

The acceleration pedal operation amount sensor 25 is configured to output a signal indicative of an acceleration pedal operation amount AP of an unillustrated accelerator pedal of the host vehicle HV.

The brake pedal operation amount sensor 26 is configured to output a signal indicative of a brake pedal operation amount BP of an unillustrated brake pedal of the host vehicle HV.

The steering sensor 27 is configured to output a signal indicative of a steering angle Sa of the host vehicle HV.

The driving mode selection switch 28 is configured to be operated by the driver to output a signal DM indicative of a driving mode selected by the driver (e.g., a normal mode, an economy mode, and a sport mode).

The other sensors 29 include various sensors outputting signals indicative of a state of the host vehicle. For example, the other sensors 29 include a steering torque sensor outputting a steering torque, and a touch sensor outputting a signal indicating whether the driver is touching the steering wheel.

The powertrain actuator 30 controls a “drive device 31 including the drive source and the transmission” of the host vehicle HV so as to adjust a driving force and a deceleration force of the host vehicle HV. For example, the drive source may include an internal combustion engine and/or a drive motor. The transmission is configured to be able to set a connection state between the drive source and drive wheels to either a power cutoff state, in which power is not transmitted between the drive source and the drive wheels (i.e., a neutral state) or a power transmission state, in which power is transmitted between the drive source and the drive wheels. When the transmission is in the power transmission state, an external force input from the drive wheels is transmitted to the drive source. Therefore, when the transmission is in the power transmission state, a deceleration force caused by engine braking is applied to the host vehicle by controlling the internal combustion engine through the powertrain actuator 30 and/or a regenerative braking force is applied to the host vehicle by controlling the drive motor through the powertrain actuator 30.

The brake actuator 40 actuates the frictional brake device 41 of the host vehicle HV to adjust a braking force (i.e., a frictional braking force) applied to the host vehicle HV.

The communication device 50 is configured to communicate with devices external to the host vehicle HV (e.g., an external traffic information center, an external weather information center, and other vehicles) to obtain various information from the external devices.

The driver monitor (driver monitoring device) 60 comprises an unillustrated driver camera configured to capture a face of the driver and a processing device. The processing device is configured to detect, based on the image data from the driver camera, a direction of the driver’s gaze, a frequency of blinking of the driver, a frequency of yawning of the driver, a direction of the driver’s face, and the like, and to output, based on the detected information, a signal indicating a degree of the driver’s wakefulness and a degree of stress felt by the driver, and the like. The degree of the driver’s wakefulness is expressed by a number between 1 and 100 by the processing device. When the degree of the driver’s wakefulness is 100, the driver is in a fully awake state. For example, the processing device decreases the degree of the driver’s wakefulness as the number of changes in the driver’s gaze direction per unit time decreases, and as the number of yawns of the driver per unit time increases. The degree of stress felt by the driver is expressed by a number between 1 and 100 by the processing device. When the degree of the stress felt by the driver is 100, the driver is under the highest stress. The processing device increases the degree of stress felt by the driver as the number of changes in the driver’s gaze direction per unit time increases and the number of changes in the direction of the driver’s face per unit time increases. It should be noted that the driver monitor 60 may include a pulse (heartbeat) sensor provided on a steering wheel. In this case, the processing device increases the degree of stress felt by the driver as the number of pulses (heartbeats) per unit time becomes higher.

The navigation ECU 70 is configured to obtain a current position of the host vehicle HV based on GPS signals received by the GPS receiver 71. The navigation ECU 70 constitutes a well-known navigation system configured to perform a route guidance based on the obtained current position and map information stored in the map information storage device 72. Furthermore, the navigation ECU 70 is configured to receive information indicative of presence/absence of a deceleration-requiring target, a type of the deceleration-requiring target, road construction locations, traffic congestion locations, or the like, and to provide the information to the driver assistance ECU 100.

### Outline of operation

The apparatus DS is configured to perform a deceleration assistance control to execute one of a coasting control, a normal deceleration control, and a system intervention deceleration control, for example, when the host vehicle speed Vh is higher than or equal to a vehicle speed threshold Vth and the accelerator pedal operation amount AP is equal to 0.

The coasting control is a control for causing the host vehicle HV to coast in a state (i.e., the power cutoff state) in which power transmission between the drive source and the drive wheels is cut off.

The normal deceleration control is a control for causing the host vehicle HV to perform normal deceleration by an engine braking control and/or a regenerative braking control in a state (i.e., the power transmission state) in which the drive source and the drive wheels are connected with each other in such a manner that the power can be transmitted therebetween.

The system intervention deceleration control is a control for causing the host vehicle HV to decelerate in the state (i.e., the power transmission state) in which the drive source and the drive wheels are connected with each other in such a manner that the power can be transmitted therebetween, by actively applying frictional brake force to the host vehicle HV using the brake device 41 in addition to the engine braking control and/or the regenerative braking control.

The coasting control is a control that improves fuel efficiency most effectively. The normal deceleration control and the system intervention deceleration control are collectively referred to as a deceleration control.

If a system intervention deceleration condition, which will be described later, is not satisfied when the host vehicle speed Vh is higher than or equal to the vehicle speed threshold Vth and the accelerator pedal operation amount AP is 0, the apparatus DS determines which one of the coasting control and the normal deceleration control is to be performed based on “information indicative of the driving circumstances (i.e., external circumstance information and other vehicle information)” and “driver information”, and performs the determined control. Therefore, the apparatus DS can reduce the possibility that the coasting control is performed in a state in which the coasting control is not suitable.

### Specific operation

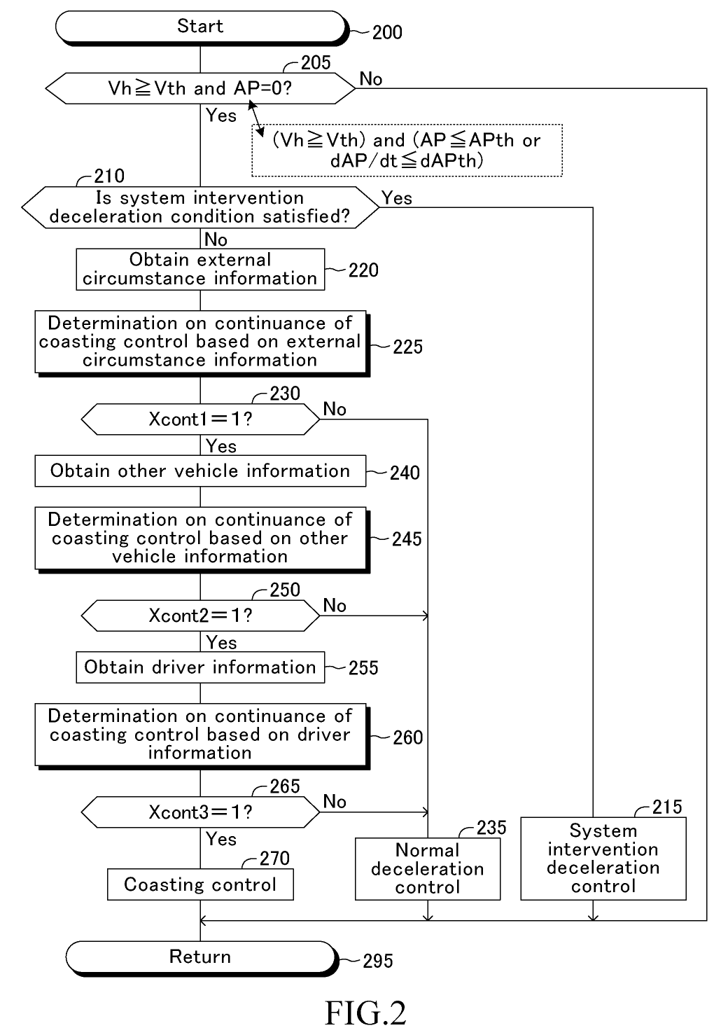

The CPU of the driver assistance ECU 10 executes a routine illustrated in FIG. 2 every time a predetermined time elapses. At an appropriate time, the CPU starts processing from S200 shown in FIG. 2, and proceeds to S205. At S205, the CPU determines whether the host vehicle speed Vh is higher than or equal to the host vehicle speed Vh that is greater than 0 and the accelerator pedal operation amount AP is 0. It should be noted that, at S205, the CPU may determine whether the host vehicle speed Vh is higher than or equal to the vehicle speed threshold Vth and whether either the accelerator pedal operation amount AP is smaller than or equal to a predetermined operation amount threshold APth or a change rate (dAP/dt) of the accelerator pedal operation amount AP is smaller than or equal to a predetermined change rate threshold dAPth that is negative. Alternatively, at S205, the CPU may determine whether the accelerator pedal operation amount AP is smaller than an operation amount threshold APth(Vh) that varies depending on the host vehicle speed Vh. The operation amount threshold APth(Vh) corresponds to the accelerator pedal operation amount AP required to maintain the host vehicle speed Vh. That is, at S205, the CPU determines whether the driver is intending to decelerate the host vehicle HV (in other words, whether the driver is not intending to accelerate the host vehicle HV). When the determination condition at S205 is not satisfied, the CPU directly proceeds from S205 to S295 so as to terminate the present routine tentatively. In this case, the CPU performs a normal acceleration control based on the accelerator pedal operation amount AP.

When the determination condition at S205 is satisfied, the CPU proceeds from S205 to S210 so as to determine whether the system intervention deceleration condition is satisfied. The system intervention deceleration condition is satisfied, for example, when the deceleration-requiring target in front of the host vehicle HV is recognized (i.e., detected) and it is determined that the host vehicle speed Vh at the time when the host vehicle HV reaches the deceleration-requiring target in a case where the normal deceleration control and/or the coasting control are performed is not expected to decrease to a target speed set for each deceleration-requiring target.

When the system intervention deceleration condition is satisfied, the CPU proceeds from S210 to S215 so as to perform the system intervention deceleration control. For example, the CPU obtains a target deceleration based on a target speed at the time when the host vehicle HV reaches the deceleration-requiring target and the host vehicle speed Vh at the present time point, and controls the powertrain actuator 30 and the brake actuator 40 in such a manner that the host vehicle decelerates at a deceleration equal to the target deceleration. Thereafter, the CPU proceeds to S295.

In contrast, when the system intervention deceleration condition is not satisfied (that is, when a “Yes” determination is made at S205, and a “No” determination is made at S210), the predetermined deceleration condition is satisfied. In this case, the CPU proceeds from S210 to S220 to obtain the external circumstance information. The external circumstance information includes information indicative of the condition of a road surface on which the host vehicle HV is traveling, information indicative of the weather in an area in which the host vehicle HV is traveling/located, information indicative of road construction location and/or traffic congestion location in the vicinity of the host vehicle.

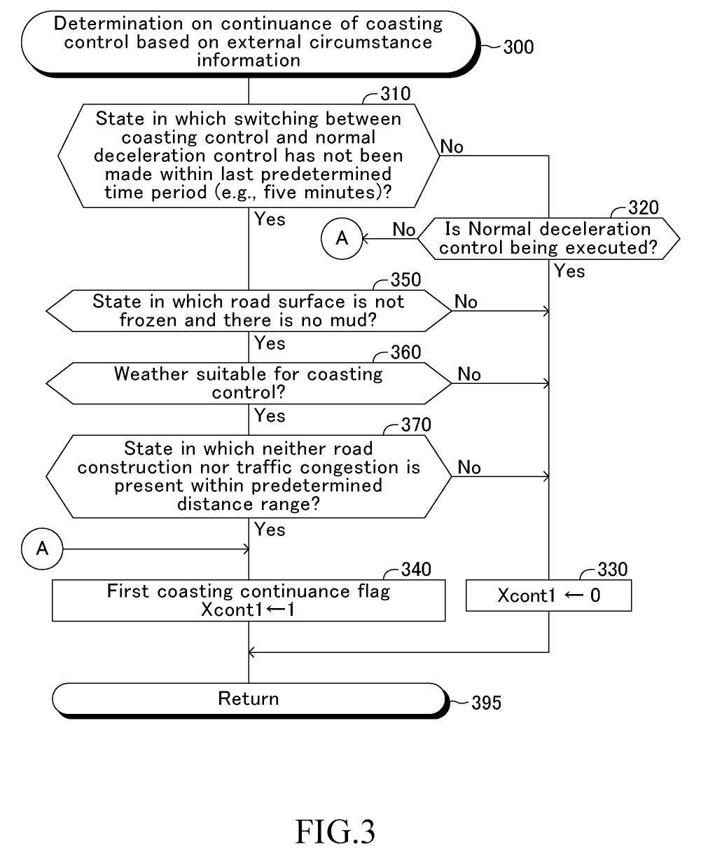

Next, the CPU proceeds to S225 to determine whether or not the coasting control should be continued (or executed) based on the external circumstance information. More specifically, the CPU executes the sub-routine shown in FIG. 3, which will be described later, so as to determine a value of a first coasting continuance flag Xcont1.

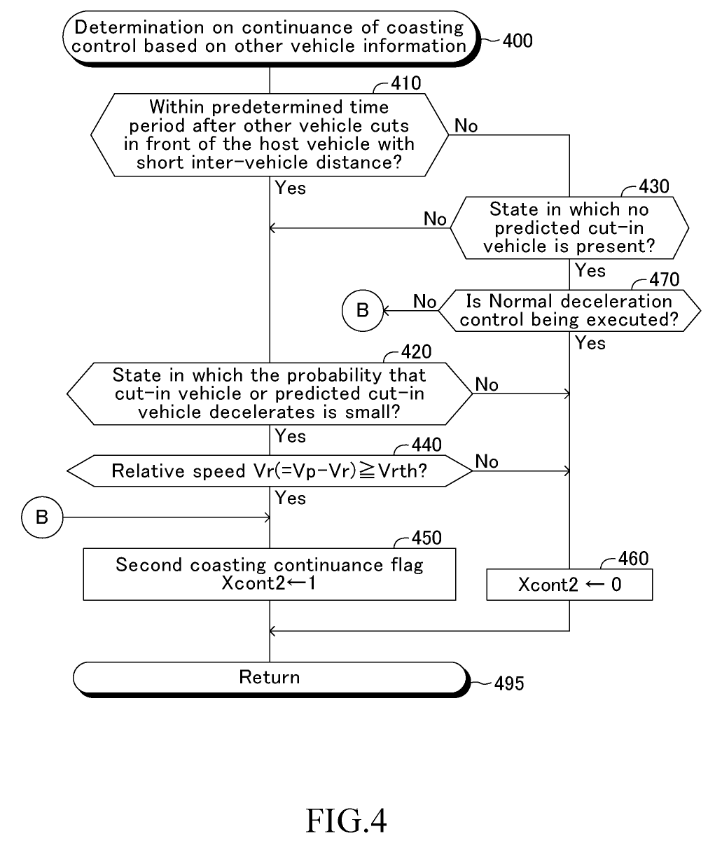

Next, the CPU proceeds to S230 to determine whether or not the value of the first coasting continuance flag Xcont1 is “1”. When the value of the first coasting continuance flag Xcont1 is “0”, the CPU proceeds from S230 to S235 so as to perform the normal deceleration control. Thereafter, the CPU proceeds to S295.

Whereas, when the value of the first coasting continuance flag Xcont1 is “1”, the CPU proceeds from S230 to S240 so as to obtain the other vehicle information. The other vehicle information includes information on other vehicles present in the vicinity of the host vehicle HV and includes information on the host vehicle. Next, the CPU proceeds to S245 to determine whether or not the coasting control should be continued (or executed) based on the other vehicle information. More specifically, the CPU executes the sub-routine shown in FIG. 4, which will be described later, so as to determine a value of a second coasting continuance flag Xcont2.

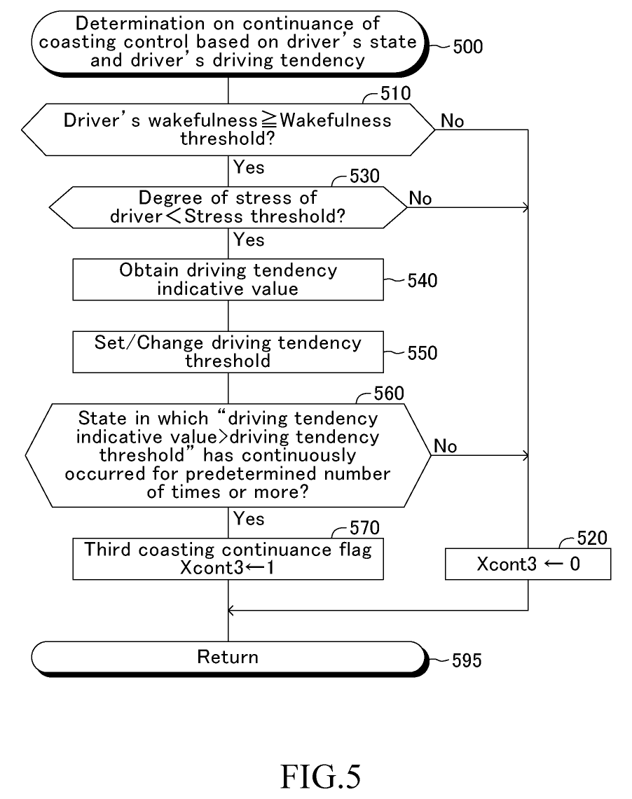

Next, the CPU proceeds to S250 to determine whether or not the value of the second coasting continuance flag Xcont2 is “1”. When the value of the second coasting continuance flag Xcont2 is “0”, the CPU proceeds from S250 to S235 so as to execute the normal deceleration control. Thereafter, the CPU proceeds to S295.

Whereas, when the value of the second coasting continuance flag Xcont2 is “1”, the CPU proceeds from S250 to S255 so as to obtain the driver information. The driver information includes information indicative of a degree of the driver’s wakefulness, information indicative of a degree of stress felt by the driver, and information indicative of the driver’s driving tendency (characteristics). Next, the CPU proceeds to S260 to determine whether or not the coasting control should be continued (or executed) based on the driver information. More specifically, the CPU executes the sub-routine shown in FIG. 5, which will be described later, so as to determine a value of a third coasting continuance flag Xcont3.

Next, the CPU proceeds to S265 to determine whether or not the value of the third coasting continuance flag Xcont3 is “1”. When the value of the third coasting continuance flag Xcont3 is “0”, the CPU proceeds from S265 to S235 so as to execute the normal deceleration control. Thereafter, the CPU proceeds to S295.

Whereas, when the value of the third coasting continuance flag Xcont3 is “1”, the CPU proceeds from S265 to S270 so as to perform the coasting control. Thereafter, the CPU proceeds to S295. As has been described, the coasting control is performed when the first to third coasting continuance flags Xcont1, Xcont2, and Xcont3 are all “1”.

### Determination on continuance of the coasting control based on the external circumstance information (FIG. 3)

As described above, when the CPU proceeds to S225 shown in FIG. 2, the CPU starts processing from S300 shown in FIG. 3 so as to proceed to S310. At S310, the CPU determines whether or not a state continues in which switching between the coasting control and the normal deceleration control has not been made within the last predetermined time period (e.g., five minutes). The CPU proceeds from S310 to S320, either when switching from the coasting control to the normal deceleration control has been made within the last predetermined time period or when switching from the normal deceleration control to the coasting control has been made within the last predetermined time period.

At S320, the CPU determines whether or not the normal deceleration control is currently being executed. Note that, if neither the normal deceleration control nor the coasting control is being executed when the CPU proceeds to S320, the CPU regards the normal deceleration control as having been executed until that time.

When the normal deceleration control is currently being executed, the CPU proceeds from S320 to S330 to set the value of the first coasting continuance flag Xcont1 to “0”. Thereafter, the CPU proceeds to S230 shown in FIG. 2 via S395. As a result, the normal deceleration control continues being executed.

In contrast, when the normal deceleration control is not currently being executed (that is, when the coasting control is being executed), the CPU proceeds from S320 to S340 to set the value of the first coasting continuance flag Xcont1 to “1”. Thereafter, the CPU proceeds to S230 shown in FIG. 2 via S395. As a result, the coasting control is permitted/allowed to be executed.

If the state continues in which switching between the coasting control and the normal deceleration control has not been made within the last predetermined time period, the CPU proceeds from S310 to S350. At S350, the CPU determines, based on the information indicative of the road surface condition from the camera sensor 21, whether or not a state is occurring in which the road surface is not frozen and there is no mud. A puddle is regarded as a mud. When the road surface is frozen or there is a mud on the road surface, the CPU proceeds from S350 to S330 so as to set the value of the first coasting continuance flag Xcont1 to “0”. Thereafter, the CPU proceeds to S230 shown in FIG. 2 via S395.

In contrast, when the road surface is not frozen and there is no mud on the road surface, the CPU proceeds from S350 to S360 so as to determine whether or not the weather in the area in which the host vehicle is located (i.e., traveling) is suitable for the coasting control. More specifically, when it is not raining, not snowing, and no fog is present, the CPU determines that the weather is suitable for the coasting control. When the weather is not suitable for the coasting control, the CPU proceeds from S360 to S330 so as to set the value of the first coasting continuance flag Xcont1 to “0”. Thereafter, the CPU proceeds to S230 shown in FIG. 2 via S395.

Whereas, when the weather is suitable for the coasting control, the CPU proceeds from S360 to S370. At S370, the CPU determines whether a state is occurring in which neither road construction nor traffic congestion is present within a predetermined distance range from the position of the host vehicle HV. When at least one of road construction and traffic congestion is present within the predetermined distance range from the position of the host vehicle HV, the CPU proceeds from S370 to S330 so as to set the value of the first coasting continuance flag Xcont1 to “0”. Thereafter, the CPU proceeds to S230 shown in FIG. 2 via S395.

In contrast, when the state is occurring in which neither road construction nhor traffic congestion is present within the predetermined distance range from the position of the host vehicle HV, the CPU proceeds from S370 to S340 so as to set the value of the first coasting continuance flag Xcont1 to “1”. Thereafter, the CPU proceeds to S230 shown in FIG. 2 via S395. As a result, the coasting control is permitted/allowed to be executed.

### Determination on continuance of the coasting control based on the other vehicle information (FIG. 4)

As described above, when the CPU proceeds to S245 shown in FIG. 2, the CPU starts processing from S400 shown in FIG. 4 so as to proceed to S410. At S410, the CPU determines whether the current time is within a predetermined time period after a state has occurred in which an other vehicle has cut in between the host vehicle HV and that other vehicle traveling immediately ahead of the host vehicle HV, and an inter-vehicle distance between the cut-in vehicle (i.e., the preceding vehicle) and the host vehicle HV has become equal to or less than an inter-vehicle distance threshold.

When the determination condition at S410 is satisfied, the CPU proceeds from S410 to S420 described later. When the determination condition at S410 is not satisfied, the CPU proceeds from S410 to S430 to determine whether a state is occurring in which an other vehicle that is predicted to be a cut-in vehicle (i.e., a predicted cut-in vehicle) is not present around the host vehicle HV. When the predicted cut-in vehicle is present, the CPU proceeds from S430 to S420. Note that, when an other vehicle that is traveling in an adjacent lane and is located in an oblique forward direction of the host vehicle HV within a predetermined first distance from the host vehicle HV is present, the CPU determines that that other vehicle is a predicted cut-in vehicle.

At S420, the CPU determines whether a state is occurring in which a probability that the cut-in vehicle or the predicted cut-in vehicle decelerates is smaller than a deceleration possibility threshold. More specifically, at S420, the CPU determines, based on information obtained through inter-vehicle communication between the cut-in vehicle and the host vehicle HV, whether a relative speed of a preceding-preceding vehicle traveling ahead of the cut-in vehicle with respect to the cut-in vehicle is less than or equal to a predetermined negative value (i.e., whether the cut-in vehicle is rapidly approaching the preceding-preceding vehicle). When the relative speed of the preceding-preceding vehicle with respect to the cut-in vehicle is less than or equal to the predetermined negative value, the CPU determines that the probability that the cut-in vehicle decelerates is greater than or equal to the deceleration possibility threshold. Furthermore, at a time point before the predicted cut-in vehicle actually cuts in, when the relative speed of the preceding vehicle of the host vehicle HV with respect to the host vehicle HV is less than or equal to the predetermined negative value, the CPU determines that the probability that the predicted cut-in vehicle will decelerate after cutting in is greater than or equal to the deceleration probability threshold.

When the state is occurring in which the probability that the cut-in vehicle or the predicted cut-in vehicle decelerates is smaller than the deceleration possibility threshold, the CPU proceeds from S420 to S440 so as to determine whether the relative speed Vr of the preceding vehicle of the host vehicle HV with respect to the host vehicle HV is greater than or equal to a relative speed threshold Vrth (Vrth > 0). The relative speed Vr is a speed obtained by subtracting a host vehicle speed Vh from a preceding vehicle speed Vp. That is, at S440, the CPU determines whether the preceding vehicle is moving away from the host vehicle HV at a relative speed greater than or equal to the relative speed threshold Vrth.

When the determination condition at S440 is satisfied, the CPU proceeds from S440 to S450 so as to set the value of the second coasting continuance flag Xcont2 to “1”. Thereafter, the CPU proceeds to S250 shown in FIG. 2 via S495. As a result, the coasting control is permitted/allowed to be executed.

Whereas, if the determination condition at S420 is not satisfied when the CPU proceeds to S420, the CPU proceeds from S420 to S460 so as to set the value of the second coasting continuance flag Xcont2 to “0”. Thereafter, the CPU proceeds to S250 shown in FIG. 2 via S495. As a result, the normal deceleration control is executed.

Furthermore, if the determination condition at S440 is not satisfied when the CPU proceeds to S440, the CPU proceeds from S440 to S460 so as to set the value of the second coasting continuance flag Xcont2 to “0”. Thereafter, the CPU proceeds to S250 shown in FIG. 2 via S495. As a result, the normal deceleration control is executed.

In addition, if the state is occurring in which the predicted cut-in vehicle is not present when the CPU proceeds to S430, the CPU proceeds from S430 to S470 so as to determine whether or not the normal deceleration control is currently being executed. Note that, if neither the normal deceleration control nor the coasting control is being executed when the CPU proceeds to S430, the CPU regards the normal deceleration control as being executed at that time.

When the normal deceleration control is being executed, the CPU proceeds from S470 to S460 so as to set the value of the second coasting continuance flag Xcont2 to “0”. Thereafter, the CPU proceeds to S250 shown in FIG. 2 via S495. As a result, the normal deceleration control is executed.

In contrast, when the normal deceleration control is not being executed, the CPU proceeds from S470 to S450 so as to set the value of the second coasting continuance flag Xcont2 to “1”. Thereafter, the CPU proceeds to S250 shown in FIG. 2 via S495.

### Determination on continuance of the coasting control based on the driver information (driver’s state, driver’s driving tendency)(FIG. 5)

As described above, when the CPU proceeds to S260 shown in FIG. 2, the CPU starts processing from S500 shown in FIG. 5 so as to proceed to S510. At S510, the CPU determines whether a degree of the driver’s wakefulness obtained from the driver monitor 60 is greater than or equal to a wakefulness threshold. When the degree of the driver’s wakefulness is less than the wakefulness threshold, the CPU proceeds from S510 to S520 so as to set the value of the third coasting continuance flag Xcont3 to “0”. Thereafter, the CPU proceeds to S265 shown in FIG. 2 via S595. As a result, the normal deceleration control is executed.

Whereas, when the degree of the driver’s wakefulness is greater than or equal to the wakefulness threshold, the CPU proceeds from S510 to S530 so as to determine whether or not a degree of stress of the driver obtained from the driver monitor 60 is less than a stress threshold. When the degree of stress of the driver is greater than or equal to the stress threshold, the CPU proceeds from S530 to S520 so as to set the value of the third coasting continuance flag Xcont3 to “0”. Thereafter, the CPU proceeds to S265 shown in FIG. 2 via S595. As a result, the normal deceleration control is executed.

Whereas, the degree of stress of the driver is less than the stress threshold, the CPU proceeds from S530 to S540 so as to obtain an indicative value (i.e., a driving tendency indicative value) indicative of the driving tendency of the driver of the host vehicle HV. The driving tendency indicative value is expressed by a number between 1 and 100. When the driving tendency indicative value is 100, the driver desires to perform economical driving (i.e., economy driving). The driving tendency indicative value becomes smaller as the driver places greater importance on safe driving. Furthermore, the driving tendency indicative value becomes much smaller as the driver places greater importance on sporty driving (active driving) as compared with safe driving. For example, the CPU sets the driving tendency indicative value to 50 when the output signal DM of the driving mode selection switch 28 indicates the normal mode, to 80 when the output signal DM indicates the economy mode, and to 20 when the output signal DM indicates the sport mode.

Furthermore, the CPU obtains an average value of an inter-vehicle distance between the host vehicle HV and a preceding vehicle, regards that the driving tendency is more safety-oriented as the average value becomes longer, and decreases the driving tendency indicative value by a predetermined value. In addition, the CPU regards that the driver has a greater tendency to desire economical driving as a period of an idle driving state, in which neither the accelerator pedal nor the brake pedal is operated, becomes longer within a predetermined period, and increases the driving tendency indicative value by a predetermined value.

Subsequently, the CPU proceeds to S550 to obtain driving tendency threshold. More specifically, the driving tendency threshold is expressed by a number between 2 and 99, and its base (standard) value is 40. The CPU obtains a frequency of sudden braking operations, namely a frequency of dBP/dt exceeding a threshold, during a period in which the coasting control was previously executed. The CPU corrects the driving tendency threshold in such a manner that the driving tendency threshold becomes greater as that frequency becomes higher. For example, when Y or more of the sudden braking operations were made in X minutes while the last coasting control was executed, the CPU increases the driving tendency threshold by a predetermined value so that the coasting control is more difficult to be executed. Alternatively, when the number of the sudden braking operations within the predetermined time in a period of execution of the coasting control is greater than the number of the sudden braking operations within the predetermined time in a period of execution of the normal deceleration control by Z or more, the CPU increases the driving tendency threshold by a predetermined value so that the coasting control is more difficult to be executed.

Next, the CPU proceeds to S560 to determine whether or not a state in which the driving tendency indicative value is greater than the driving tendency threshold has continuously occurred for a predetermined number of times or more. The reason why the CPU determines whether or not the state in which the driving tendency indicative value is greater than the driving tendency threshold has continuously occurred for a plurality of times is that it is difficult to accurately obtain the driving tendency indicative value itself.

When the determination condition at S560 is not satisfied, the CPU proceeds from S560 to S520 so as to set the value of the third coasting continuance flag Xcont3 to “0”. Thereafter, the CPU proceeds to S265 shown in FIG. 2 via S595. As a result, the normal deceleration control is executed. Whereas, when the determination condition at S560 is satisfied, the CPU proceeds from S560 to S570 so as to set the value of the third coasting continuance flag Xcont3 to “1”. Thereafter, the CPU proceeds to S265 shown in FIG. 2 via S595. As a result, the coasting control is executed.

As has been described, the apparatus DS executes either the coasting control or the normal deceleration control, based on the information indicative of the driving circumstances of the host vehicle (i.e., the external circumstance information, the other vehicle information, or the like), when a predetermined deceleration condition (in other words, a coasting control permission condition) is satisfied. Therefore, the coasting control is not executed when the driving circumstances are not suitable for the coasting control. As a result, the probability that the driver feels uneasy can be reduced.

The present disclosure is not limited to the above-described embodiment, and various modifications as described below, can be adopted within the scope of the present disclosure. For example, the present disclosure can be applied to an autonomous driving vehicle in a state where a driving mode has been transitioned from autonomous driving to manual driving by the driver.

Furthermore, S310 and S320 shown in FIG. 3 can be omitted. In such a case, the CPU proceeds from S300 to S350. In addition, any one or two of steps from S350 to S370 shown in FIG. 3 can be omitted.

At S370, it may be determined whether or not a state is occurring in which only road construction is not present within a predetermined distance range from the position of the host vehicle HV. Furthermore, at S370, it may be determined whether or not a state is occurring in which only traffic congestion is not present within the predetermined distance range from the position of the host vehicle HV. Furthermore, when a planned traveling route has been determined in (by) the navigation system, the CPU may determine at S370 whether or not a state is occurring in which no construction and/or traffic congestion site is present in a region on the planned traveling route within a predetermined distance along the planned traveling route from the current position of the host vehicle HV.

Furthermore, S410, S430, and S470 shown in FIG. 4 can be omitted. In such a case, the CPU proceeds from S400 to S420. In this case, at S420, the CPU may determine whether or not a state is occurring in which the probability that the preceding vehicle decelerates is small. Furthermore, steps S410 through S430 and step S470 may also be omitted. In such a case, the CPU proceeds from S400 to S440.

In addition, the CPU may set the value of the second coasting continuance flag Xcont2 to “0” when the inter-vehicle distance between the host vehicle HV and the preceding vehicle is shorter than the inter-vehicle distance threshold, and to “1” when the inter-vehicle distance between the host vehicle HV and the preceding vehicle is longer than or equal to the inter-vehicle distance threshold.

Furthermore, the CPU may set the value of the second coasting continuance flag Xcont2 to “0” when the inter-vehicle distance between the host vehicle HV and/or the preceding vehicle is less than the inter-vehicle distance threshold or the relative speed Vr is less than the relative speed threshold Vrth, and to “1” when the inter-vehicle distance is greater than or equal to the inter-vehicle distance threshold and the relative speed Vr is greater than or equal to the relative speed threshold Vrth.

Furthermore, the CPU may omit either one of the processes from S220 to S230 shown in FIG. 2 (that is, the determination on continuance of the coasting control based on the external circumstance information) or the processes from S240 to S250 shown in FIG. 2 (that is, the determination on continuance of the coasting control based on the other vehicle information). Furthermore, the CPU may omit the processes from S255 to S265 shown in FIG. 2 (that is, the determination on continuance of the coasting control based on the driver information including the driver’s state and the driver’s driving tendency).

What is claimed is:

1. A driver assistance apparatus comprising a controller configured to execute either a coasting control or a deceleration control, when a predetermined deceleration condition for decelerating a host vehicle becomes satisfied, wherein
said coasting control is a control for setting a connection state between a drive source of said host vehicle and drive wheels of said host vehicle to a power cutoff state in which power is not transmitted between said drive source and said drive wheels and for causing said vehicle to coast, and
said deceleration control is a control for setting said connection state to a power transmission state in which power is transmitted between said drive source and said drive wheels and for causing said vehicle to decelerate by causing an external force input from said drive wheels to be transmitted to said drive source,
and wherein
said controller is configured to:
obtain information indicative of driving circumstances of said host vehicle; and
determine, based on said obtained information indicative of the driving circumstances of said host vehicle, which one of said coasting control and said deceleration control is to be executed.

2. The driver assistance apparatus according to claim 1, wherein
said controller is configured to obtain, as said information indicative of the driving circumstances, at least one of information indicative of a condition of a road surface on which said host vehicle is traveling, or information indicative of weather in an area in which said host vehicle is traveling, or information indicative of a road construction location or a traffic congestion location in said area.

3. The driver assistance apparatus according to claim 1, wherein
said controller is configured to obtain, as said information indicative of the driving circumstances, information indicative of a traveling state of a preceding vehicle of said host vehicle.

4. The driver assistance apparatus according to claim 1, wherein
said controller is configured to:
further obtain at least one of information indicative of a state of a driver of said host vehicle or information indicative of driving tendency of said driver; and
determine, based on said obtained information indicative of said state of said driver of said host vehicle or said obtained information indicative of said driving tendency of said driver, which one of said coasting control and said deceleration control is to be executed.

5. A driver assistance method comprising a step of executing either a coasting control or a deceleration control, when a predetermined deceleration condition for decelerating a host vehicle becomes satisfied, wherein
said coasting control is a control for setting a connection state between a drive source of said host vehicle and drive wheels of said host vehicle to a power cutoff state in which power is not transmitted between said drive source and said drive wheels and for causing said vehicle to coast, and
said deceleration control is a control for setting said connection state to a power transmission state in which power is transmitted between said drive source and said drive wheels and for causing said vehicle to decelerate by causing an external force input from said drive wheels to be transmitted to said drive source,
and wherein
said method further comprises:
a step of obtaining information indicative of driving circumstances of said host vehicle; and
a step of determining, based on said obtained information indicative of the driving circumstances of said host vehicle, which one of said coasting control and said deceleration control is to be executed.

6. The driver assistance method according to claim 5, wherein
said step of obtaining information indicative of driving circumstances of said host vehicle is a step of obtaining, as said information indicative of the driving circumstances, at least one of information indicative of a condition of a road surface on which said host vehicle is traveling, or information indicative of weather in an area in which said host vehicle is traveling, or information indicative of a road construction location or a traffic congestion location in said area.

7. The driver assistance method according to claim 5, wherein
said step of obtaining information indicative of driving circumstances of said host vehicle is a step of obtaining, as said information indicative of the driving circumstances, information indicative of a traveling state of a preceding vehicle of said host vehicle.

8. The driver assistance method according to claim 5, further comprising:
a step of obtaining at least one of information indicative of a state of a driver of said host vehicle or information indicative of driving tendency of said driver; and
a step of determining, based on said obtained information indicative of said state of said driver of said host vehicle or said obtained information indicative of said driving tendency of said driver, which one of said coasting control and said deceleration control is to be executed.

9. A non-transitory computer-readable storage medium storing a program, said program comprising instructions which, when executed by a processor of a controller mounted on a host vehicle, cause the processor to perform a step of executing either a coasting control or a deceleration control, when a predetermined deceleration condition for decelerating a host vehicle becomes satisfied, wherein
said coasting control is a control for setting a connection state between a drive source of said host vehicle and drive wheels of said host vehicle to a power cutoff state in which power is not transmitted between said drive source and said drive wheels and for causing said vehicle to coast; and
said deceleration control is a control for setting said connection state to a power transmission state in which power is transmitted between said drive source and said drive wheels and for causing said vehicle to decelerate by causing an external force input from said drive wheels to be transmitted to said drive source,
and wherein
said instructions which, when executed by said processor, cause the processor to perform:
a step of obtaining information indicative of driving circumstances of said host vehicle; and
a step of determining, based on said obtained information indicative of the driving circumstances of said host vehicle, which one of said coasting control and said deceleration control is to be executed.
